(19) United States
(12) Patent Application Publication
(10) Pub. No.: US 2017/0232412 A1
(43) Pub. Date: Aug. 17, 2017

(54) AGITATOR PROVIDED WITH HEATER

(71) Applicant: SAKAGUCHI E.H. VOC CORP., Chiyoka-ku, Tokyo (JP)

(72) Inventors: Satoshi SUGANO, Chiyoka-ku, Tokyo (JP); Mayumi HACHIYA, Chiyoka-ku, Tokyo (JP)

(21) Appl. No.: 15/502,986

(22) PCT Filed: Jul. 9, 2015
(86) PCT No.: PCT/JP2015/069720

§ 371 Date: Feb. 9, 2017

(30) Foreign Application Priority Data
Aug. 29, 2014 (JP) 2014-175841

(51) Int. Cl. B01F 15/06; B01F 7/16

(52) U.S. Cl. CPC B01F 15/066; B01F 7/1625; B01F 2015/062

(57) ABSTRACT

An object of the present invention is to efficiently agitate and heat a liquid. To this end, the present invention provides an agitator supported on a rotating shaft, wherein such agitator has: a liquid suction port provided on the rotating shaft and/or near the rotating shaft; a liquid discharge port provided farther away than the liquid suction port from the rotating shaft, which is interconnected to the liquid suction port through an interconnecting channel; and a heater provided for heating the interior of the interconnecting channel and/or liquid discharge port.

### TECHNICAL FIELD

The present invention relates to an agitator provided with a heater used for agitating a liquid, etc.

### BACKGROUND ART

Among agitators for agitating a liquid, etc., a rotating body for agitation that agitates a liquid by causing it to flow out using centrifugal forces, is known as described in Patent Literature 1, which is characterized in that it has: a body constituted by a circular cross-section shape positioned vertically to the direction of its rotating shaft, suction ports provided on the surface of the body, discharge ports provided on the surface of the body, and interconnecting channels connecting the suction ports and discharge ports wherein the suction ports are positioned closer to the rotating shaft than the discharge ports and the discharge ports are positioned toward the outer side with respect to the rotating shaft in the radial direction compared to the suction ports; and according to such agitator, efficient agitation can be achieved.

Just like the invention described in Patent Literature 1, devices designed to agitate a liquid by causing it to flow out around a rotating shaft inside an agitation container using centrifugal forces, are also described in Patent Literatures 2 to 6. The inventions described in these literatures, despite differences in detail, are all constituted in such a way that a rotating member is provided in an agitation container, while flow channels are provided between disks or on a disk that the rotating member has, where a liquid suctioned in from near the rotating shaft passes through these flow channels and flows out from the circumferential face of the disk(s), so that the liquid is agitated in the agitation container.

Also, as described in Patent Literature 7, an agitation device where agitation blades for agitating a liquid, etc., are connected to a rotating shaft and a heater is embedded into the rotating shaft to agitate and heat the liquid at the same time is known, and also as described in Patent Literature 8, an agitation device where a heating medium is passed through agitation blades positioned at the center of the agitation pot for agitating near the side wall of the pot, is known.

### BACKGROUND ART LITERATURE

### Patent Literature

[Patent Literature 1] Japanese Patent No. 4418019

[Patent Literature 2] Japanese Patent Laid-open No. Hei 09-276681

[Patent Literature 3] Japanese Patent Laid-open No. 2010-260031

[Patent Literature 4] Japanese Patent Laid-open No. Hei 08-182924

[Patent Literature 5] Japanese Patent Laid-open No. Hei 11-114396

[Patent Literature 6] Japanese Patent Laid-open No. Sho 51-008669

[Patent Literature 7] Japanese Patent Laid-open No. 2002-316033

[Patent Literature 8] Japanese Utility Model Laid-open No. Sho 64-012633

### SUMMARY OF THE INVENTION

### Problems to Be Solved by the Invention

According to the devices described in Patent Literatures 1 to 6, the liquid can be agitated more uniformly, there is less accidental danger because the agitation blades do not rotate at high speed during agitation, and the agitation process can be implemented in a stable manner because the blades do not bump against the interior wall of the agitation container.

If agitation is to be accompanied by heating, however, a heater or other heating device separate from the agitation device must be introduced into the agitation container, and as a result, even when flows of liquid are formed inside the agitation container to allow for uniform agitation, these flows will be inhibited by the separately introduced heater.

Furthermore, when the strength of agitation is to be changed in the agitation process, the strength of heating must also be adjusted at the same time; if agitation and heating are performed by separate devices, however, it is difficult to control these strengths in an integrated manner.

Additionally, when agitating a liquid whose viscosity is relatively high, for example, a situation where the installed location of the heater in the agitation container is away from the installed location of the agitation device makes it difficult to deliver the liquid into the agitation container from areas where its viscosity drops due to heating, which means that it takes a long time before the liquid can be agitated smoothly due to the viscosity drops of the liquid by heating.

According to the devices that are integrally constituted by a heating mechanism and an agitation device, as described in Patent Literatures 7 and 8, heating devices are built into the shaft that rotates the agitation blades and also in the agitation blades that extend to cover the entire agitation container, and consequently the flows of liquid created by agitation will not be inhibited by the heaters.

According to the device described in Patent Literature 7, however, the flows of liquid formed by the agitation blades are sometimes away from the locations heated by the heaters, in which case it becomes difficult, when agitating a liquid of high viscosity under heating, to quickly spread the liquid throughout the agitation container from areas where its viscosity drops due to heating.

Also, with the device in Patent Literature 8, the heating medium is passed throughout the interior of the rotating agitation blades that extend to cover the entire agitation container, and this requires a complex structure for supplying into the rotating shaft the heating medium that has been heated outside the agitation container, and also makes it difficult to supply the heating medium uniformly to the entire agitation blades, and since the rotating blades themselves become heavy, a large amount of energy will be required for agitation.

### Means for Solving the Problems

The present invention aims to solve the aforementioned problems and specifically has the following constitutions:
1. An agitator supported on a rotating shaft, wherein such agitator has:
a liquid suction port provided on the rotating shaft and/or near the rotating shaft;
a liquid discharge port provided farther away than the liquid suction port from the rotating shaft, which is interconnected to the liquid suction port through an interconnecting channel; and
a heater provided for heating the interior of the interconnecting channel and/or liquid discharge port.
2. An agitator according to 1, wherein the heater is provided adjacent to the interconnecting channel and/or near the liquid discharge port.
3. An agitator according to 1 or 2, wherein the heater is provided inside the agitator.
4. An agitator according to any one of 1 to 3, wherein it has one or more liquid suction ports and one or more liquid discharge ports that are independent of each other, and the interconnecting channel is provided in a manner allowing for flows of liquid to be branched and/or merged.
5. An agitation device comprised by placing one or more agitators according to any one of 1 to 4 in the direction of the rotating shaft.

### Effects of the Invention

The agitator proposed by the present invention has no rotating blade; instead, it agitates a liquid by suctioning it in from the liquid suction port and then using centrifugal forces to cause it to be discharged from the liquid discharge port provided on the rim of the agitator, and because the heaters are provided in such a way as to heat the interior of the interconnecting channel and/or liquid discharge port and thereby heat the liquid near the discharge port and in the interconnecting channel, the viscosity of the liquid drops as it is heated in the agitator as described above, and consequently the liquid whose flowability has thus increased can be discharged more smoothly to the direction toward the wall of the agitation container from the liquid discharge port.

In other words, as the liquid in the agitator receives the centrifugal forces generated by the rotation of the agitator, its discharge from the discharge port of the agitator is promoted, while at the same time it is heated in the interconnecting channel and the resulting drop in viscosity increases the flowability, which makes it easier for the liquid to flow toward the discharge port.

As a result, the agitator can start rotating relatively without receiving much fluid resistance, even when the viscosity of the liquid is relatively high at the start of agitation, which means that the rotation of the agitator under continuous heating allows the liquid to be heated and agitated quickly and uniformly, with a smaller amount of energy required for agitation.

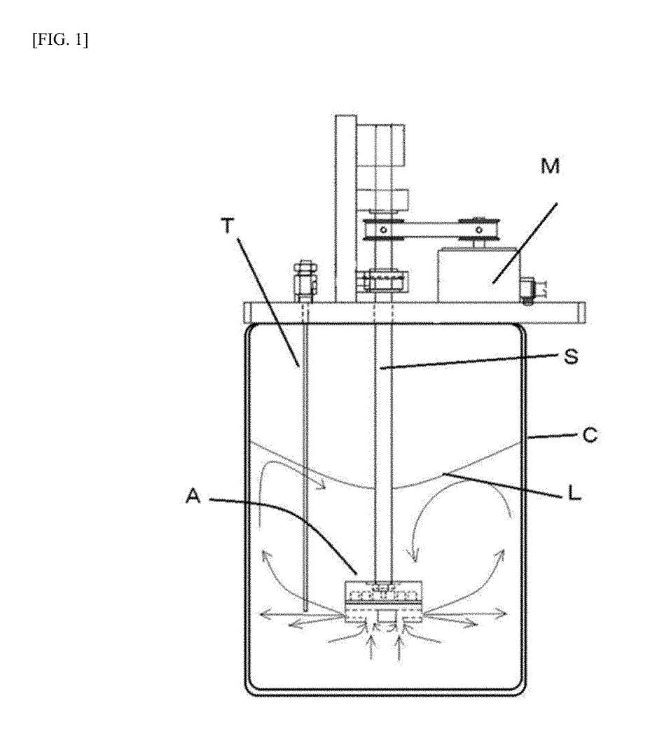

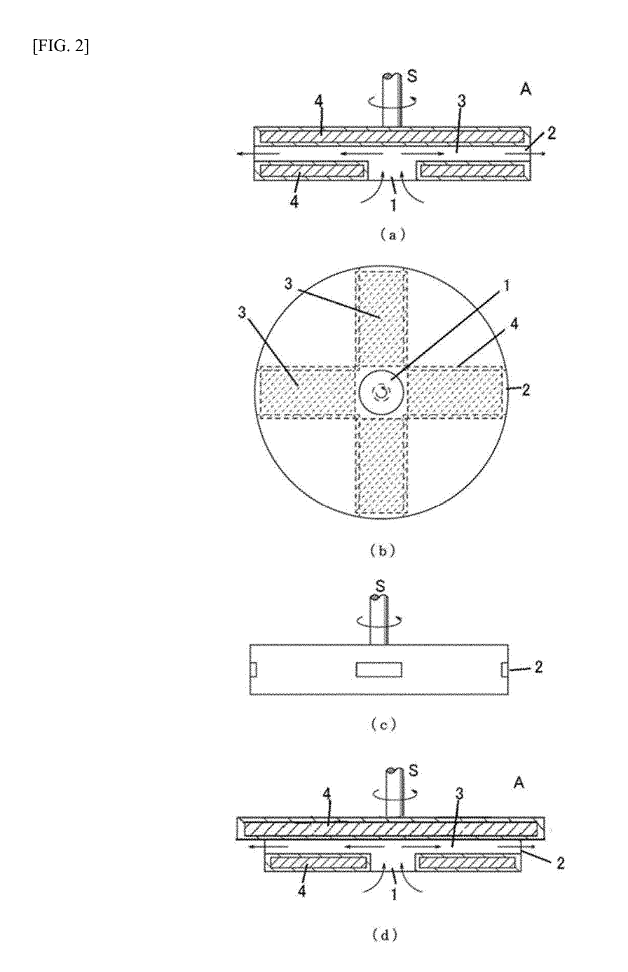

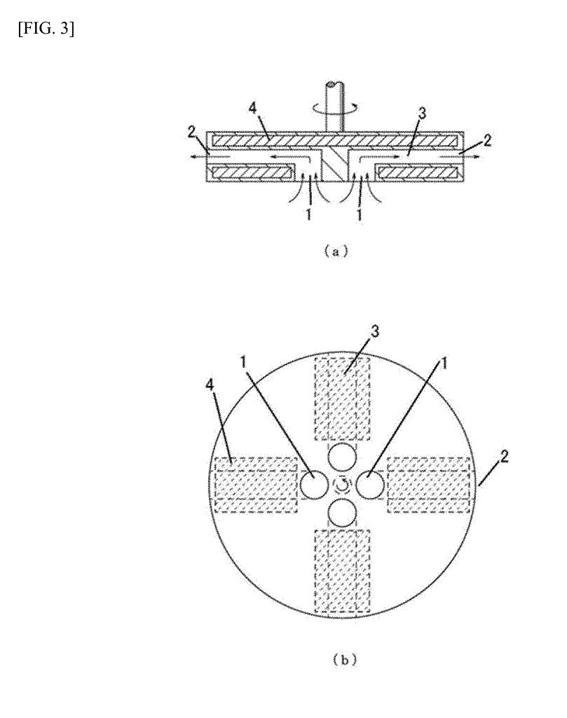

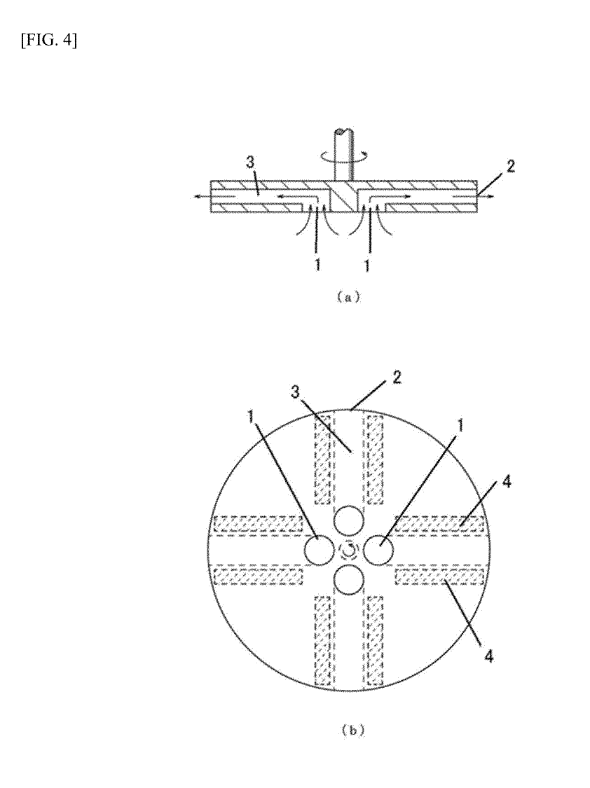

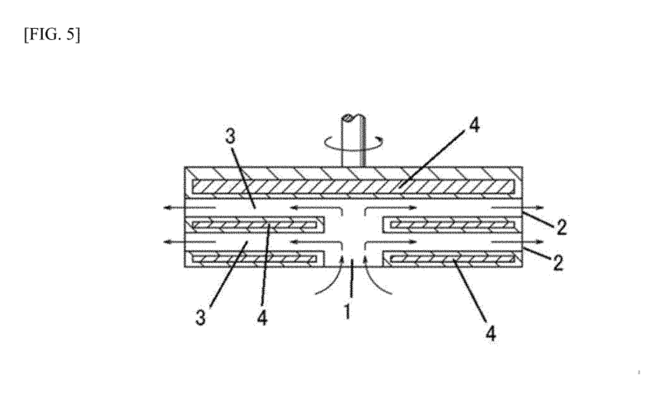

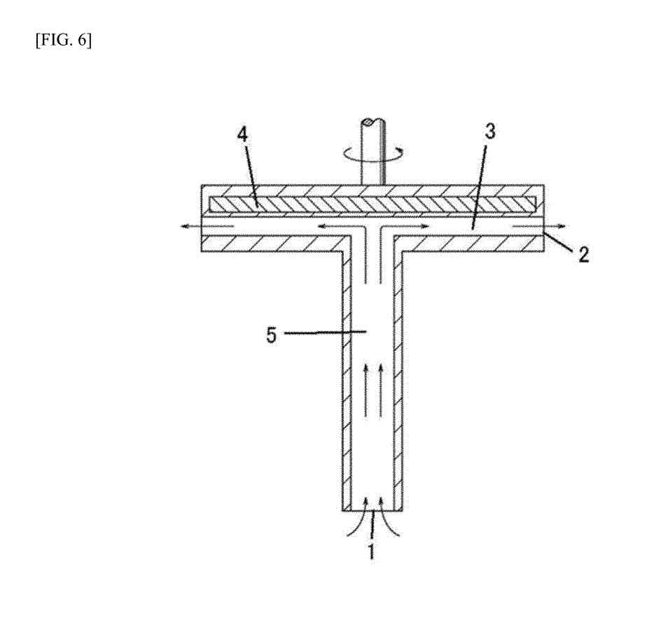

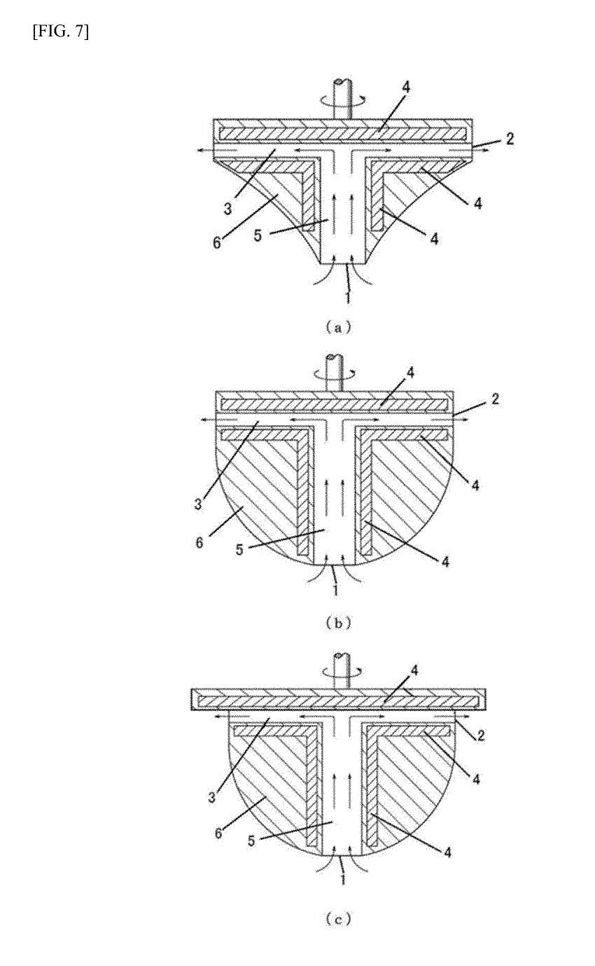

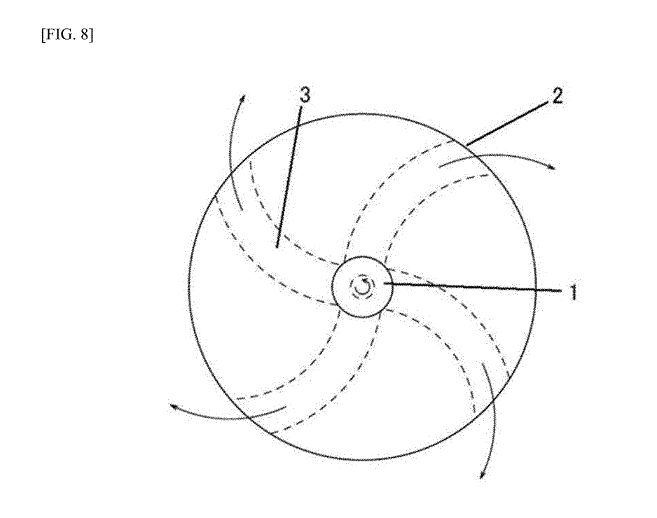

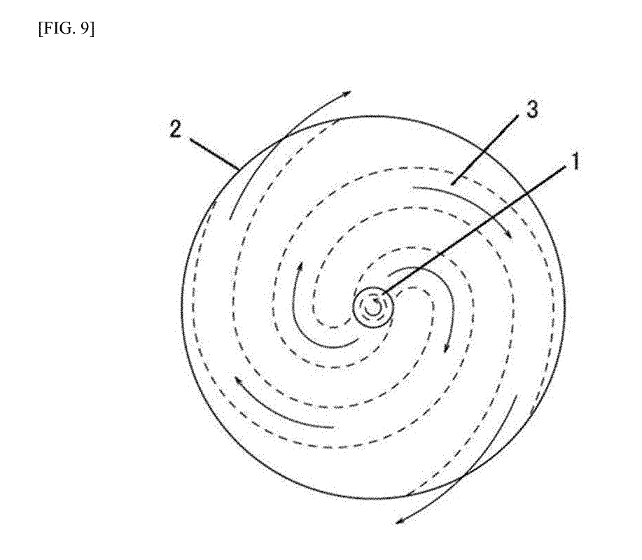

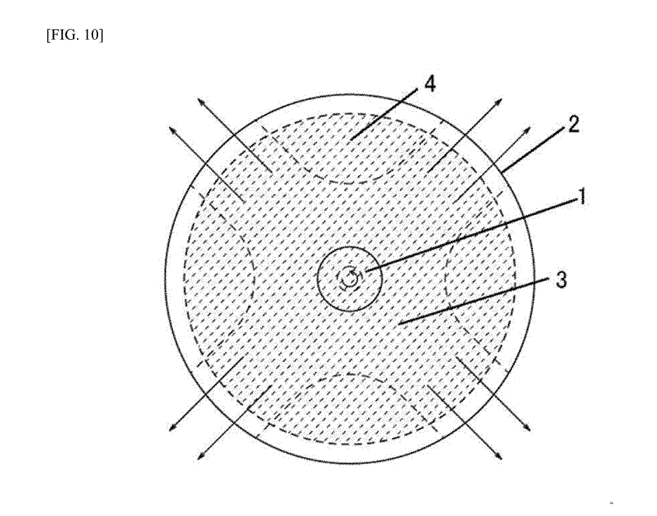

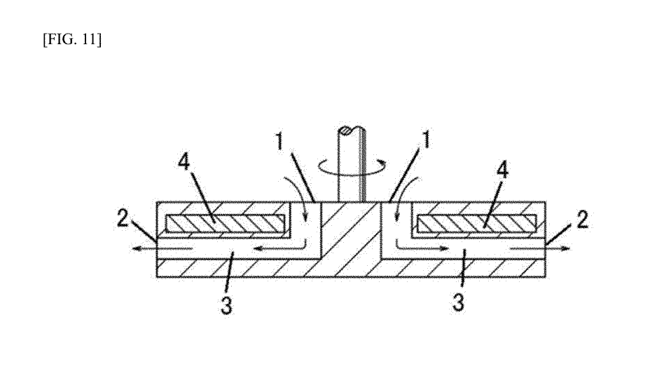

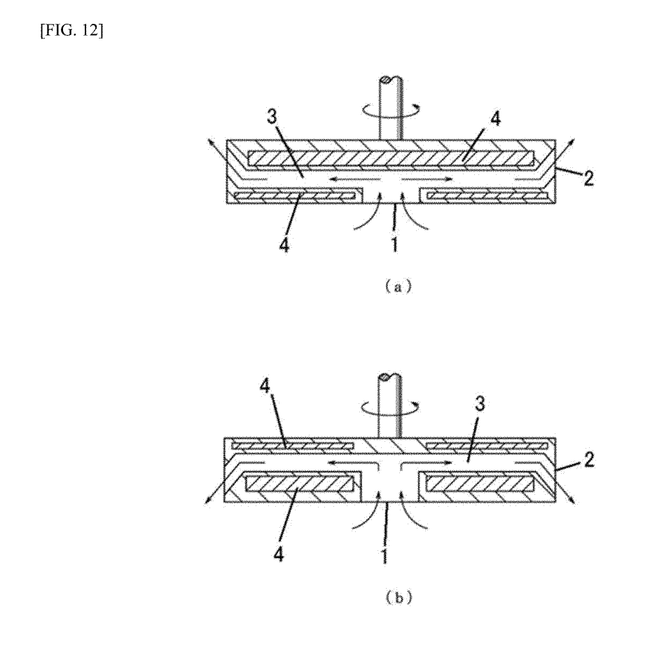

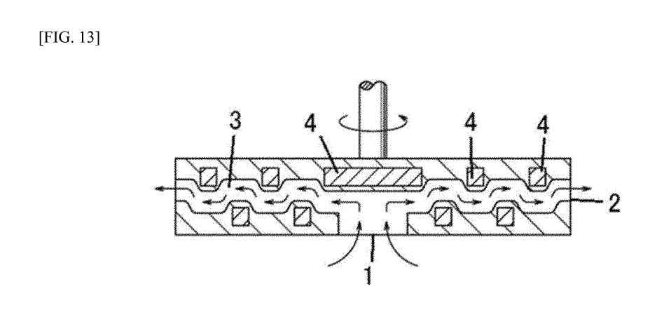

### BRIEF DESCRIPTION OF THE DRAWINGS

[FIG. 1] Overview of an agitation device using the agitator proposed by the present invention

[FIG. 2] An example of the agitator proposed by the present invention

[FIG. 3] An example of the agitator proposed by the present invention

[FIG. 4] An example of the agitator proposed by the present invention

[FIG. 5] An example of the agitator proposed by the present invention

[FIG. 6] An example of the agitator proposed by the present invention

[FIG. 7] An example of the agitator proposed by the present invention

[FIG. 8] An example of the agitator proposed by the present invention

[FIG. 9] An example of the agitator proposed by the present invention

[FIG. 10] An example of the agitator proposed by the present invention

[FIG. 11] An example of the agitator proposed by the present invention

[FIG. 12] An example of the agitator proposed by the present invention

[FIG. 13] An example of the agitator proposed by the present invention

### DESCRIPTION OF THE SYMBOLS

1 - - - Suction port

2 - - - Discharge port

3 - - - Interconnecting channel

4 - - - Heater

5 - - - Vertical interconnecting channel

6 - - - Cover

C - - - Agitation container

L - - - Liquid

S - - - Rotating shaft

M - - - Motor

T - - - Thermometer

A - - - Agitator

### MODE FOR CARRYING OUT THE INVENTION

Basic features regarding the agitator proposed by the present invention are explained.

Basically the agitator proposed by the present invention is connected to a rotating shaft which is rotated by means of a motor or other known drive source, where the agitator, as it rotates, remains immersed in a liquid inside an agitation container and therefore the liquid inside the agitation container is suctioned into the agitator and then discharged therefrom.

The liquid to be agitated is not limited in any way, so long as it is a liquid, emulsion, dispersion liquid, or other substance which has so-called flowability and is agitated in liquid state; accordingly, the present invention is used for liquids that are agitated using any known agitation device.

In particular, the present invention is desirably used for liquids that are agitated under heating (including liquids that are in solid state when not heated, but change to liquid state once agitated under heating).

The agitator proposed by the present invention as described above, can be installed, together with its rotation mechanism, in place of any device or structure pertaining to agitation and heating, especially in an agitation device capable of performing agitation under heating, such as: a device that heats a liquid from the exterior face of an agitation container; a device that performs agitation while heating at the same time by using a heater introduced or installed in an agitation container separately from an agitator; a device whose agitation blade has a heating device embedded in it; or a device having a circulating channel with a heating means provided outside an agitation container, where the liquid to be heated is circulated through and heated in the circulating channel.

Unlike those conventional devices designed for agitation, or specifically devices that agitate a liquid by suctioning it into and then discharging it out of an agitator, the agitator proposed by the present invention is such that a liquid is suctioned in from above its rotating shaft and/or near the rotating shaft and then heated inside the agitator, thereby lowering the viscosity of the liquid and thus increasing the flowability of the liquid inside the agitator, and consequently promoting the discharge of the liquid from near the peripheral rim of the agitator. In other words, the increased flowability allows the liquid, which is discharged by means of centrifugal forces from the peripheral rim of the rotating agitator, to be discharged with a greater momentum, while at the same time the liquid is agitated in an efficient and uniform manner and also heated in a quick and uniform manner.

Put differently, more liquid can be suctioned in from the suction port of the agitator compared with when the liquid is not heated inside the agitator, and the entire liquid in the agitation container can be agitated more quickly to achieve a more uniform temperature.

It should be noted that, in the context of the present invention, the expressions “on the rotating shaft” and “near the rotating shaft” include directly on the rotating shaft that rotates the agitator and near such rotating shaft, as well as any location not directly on the rotating shaft but on the agitator along a line extended from the rotating shaft and near such location.

Additionally, when the liquid to be agitated is unstable, or especially when it is a liquid subject to reaction, property change, etc., at high temperature, under the prior art any increase in the temperature of the surface of the heating device inside the agitation container would cause the temperature to rise excessively in some parts of the liquid that come in contact with this surface, which would then trigger reaction or property change and thus decrease the quality of the liquid as a whole, and consequently the liquid must be heated over many hours in order to achieve uniform heating without causing its quality to drop.

According to the present invention, on the other hand, the liquid passes by the heated interior face of the agitator at high speed, which means that the heated surface is always in contact with unheated liquid and any excessive, partial heating of the liquid is prevented as a result.

For the material of each member used in the agitator proposed by the present invention, any known material for agitation devices may be adopted.

For the agitator, any material selected from metal, ceramics, resin, wood, etc., may be adopted, while the rotating shaft is made of metal, ceramics or resin. Also, the interior of the agitator may be solid, and although the remainder including the interconnecting channel and heater may be hollow, preferably they are solid from the viewpoint of heating the interior of the interconnecting channel because the heat from the heater is transmitted to the interconnecting channel.

Furthermore, a thermometer may be installed at a desired position inside the agitator. This way, differences in the temperature of the liquid between before and after passing each part in the agitator, for example, can be detected and controlled, to allow for more appropriate heating.

For the heater, any known heater may be used that can be adopted for agitating a liquid inside an agitation container, but it must be shaped and sized to allow for connection to the agitator or installation inside the agitator.

If metal, resin, or wood is used to form the interconnecting channel and exterior face to achieve the agitator proposed by the present invention, these members formed by any such material may be integrally combined with a heater; if resin is used, for example, a heater may be placed beforehand at each specified location in a mold where an interconnecting channel, discharge port, or suction port is to be formed, so that when resin is filled in the mold, the agitator proposed by the present invention is obtained based on an integrated resin-heater structure.

The liquid to be agitated by such agitation device adopting the agitator proposed by the present invention is a liquid that must be agitated under heating.

Examples of such liquid include those traditionally used for heating, heat reserving, and other purposes, such as reagent reaction processes in the chemical industry, manufacturing processes in the food industry, heat reserving of food and drinks, heat reserving of blood, heating of reagents, chemicals, and water, heating of reagents and cleaning solutions in chemical manufacturing as well as electronic component and semiconductor manufacturing processes, and heat reserving in water bath, among others.

Depending on which of these purposes applies, the agitation container may be, for example, a tank, bottle, water bath, or other container used for heating or heat-reserving a liquid such as blood, chemical, food, drink, etc., by introducing the agitator into it.

And, depending on which of these purposes applies, the shape, structure, size, and other details of the agitator A proposed by the present invention may be selected according to the heating or heat-reserving conditions, such as heating to or reserving heat at temperatures slightly higher than room temperature, heating to or reserving heat at high temperatures, increasing or decreasing the rate of rise in the temperature of the liquid, the number of revolutions, etc.

The present invention is explained below based on the drawings.

FIG. 1 is an overview of an agitation device using agitator A proposed by the present invention.

The constitution, where a motor M that rotates a rotating shaft S is provided above an agitation container C and an agitation member is provided at the tip of the rotating shaft S by means of screws, engagement, welding, or other known means, is the same as the constitution of the type of agitation device whose rotating shaft is installed vertically or any other general device comprising an agitation container having such agitation device.

Furthermore, a thermometer T is provided, for example, for measuring, from above, the temperature of a liquid L at a desired location.

In this FIG. 1, an agitator A with a heating device for heating an interconnecting channel (not illustrated) is provided at the bottom end of the rotating shaft S, and as it is rotated, the liquid L flows as indicated by the arrows in FIG. 1, to be uniformly agitated and uniformly heated.

How to agitate the liquid inside the agitation container using the agitator A shown in FIG. 1 is explained. This same method basically applies to agitators A having different shapes and/or structures as shown in the figures below.

The agitator A is immersed in the liquid inside the agitation container, and then the agitator A rotates in the direction of rotation of the rotating shaft S as shown in FIG. 2 (a).

As the agitator A is immersed in the liquid, the agitator A, especially its suction port 1, receives the liquid pressure directly from the liquid, as well as the pressing force resulting from the agitator A dropping deeper into the liquid for immersion.

These forces cause the liquid to enter the suction port 1 to fill the interconnecting channels 3 at least partially.

When the agitator A in this state is rotated in the condition of FIG. 2 (a), for example, centrifugal forces will act upon the liquid inside interconnecting channels 3, and the liquid will move toward discharge ports 2, or specifically toward the outer side of the agitator A in the radial direction, to be eventually discharged from the discharge ports 2 into the liquid outside the agitator A. The discharged liquid, because it has been heated by heaters 4 and also has lower viscosity compared to before the liquid was heated, flows upward after having been discharged from the agitator A and, also due to the centrifugal forces received from the agitator A, diffuses throughout the liquid. It should be noted that, because liquid near the rotating agitator A also receives forces in the direction of rotation, this liquid also follows the liquid discharged from the discharge ports and moves inside the agitation container.

Such movement of liquid inside the interconnecting channels 3 causes the liquid in the interconnecting channels 3 to decrease, and therefore new liquid near the suction port 1 is suctioned in from the suction port 1 to compensate for the decrease. As this movement inside the interconnecting channels 3 occurs continuously, liquid is suctioned in from the suction port 1 continuously and the heated liquid is discharged from the discharge ports 2 continuously, thereby allowing this agitator to perform heating and agitation at the same time.

The liquid present near the suction port 1 is heated by the heaters 4 inside the interconnecting channels 3 and its temperature rises as a result, and its viscosity also drops, and in this condition it is moved toward the discharge ports 2 by the action of centrifugal forces and eventually discharged from the discharge ports 2. When this happens, the heat generated by the heaters 4 heats the walls of the interconnecting channels 3 and discharge ports 2 in the form of thermal conduction, and the liquid inside the interconnecting channels 3 is heated by these walls. Also, some of the heat generated by the heaters 4 is transferred to the exterior face of the agitator A to heat the liquid on the exterior face of the agitator A, and this has the effect of lowering the viscosity of the liquid around the agitator and thereby promoting the flowability of the liquid, although the specific effect varies depending on the structure and shape of the agitator A.

As such movement of the liquid continues, the liquid inside the agitation container is agitated quickly to a uniform temperature.

It should be noted that, to energize the heaters 4 provided in the agitator A, wires that connect to the heaters 4 are provided inside the rotating shaft S and leads connected to the wires are provided on top of the rotating shaft S, so that power is supplied from outside the rotating shaft via the leads.

The following explains several specific shapes and structures of agitators A using the figures below.

All agitators A shown in the respective figures are all rotated by a rotating shaft provided vertically to the liquid surface inside an agitation container.

FIG. 2 (a) is a section view of an agitator A. This agitator A is shaped like a disk, and one side of the disk is connected to the rotating shaft S. A suction port 1 is provided at the center of the disk on the other side along a line extended from the rotating shaft S, and discharge ports 2 corresponding to the suction port 1 are provided on the peripheral face of the agitator A, where the suction port 1 and multiple discharge ports 2 are connected by interconnecting channels 3.

Here, heaters 4 are provided above and below each interconnecting channel 3 to heat the liquid inside the interconnecting channel. Not only above and below the interconnecting channel 3, heaters 4 can also be placed on sides of the interconnecting channel 3 to surround the interconnecting channel 3, where the heaters 4 and interconnecting channel 3 may be connected by metal or other members having good thermal conductivity to actively transfer the heat from the heaters 4 to the interconnecting channel 3.

It should be noted that not all of the heat generated by the heaters 4 is consumed for the purpose of heating the interior of the interconnecting channel 3; as a result, some heat is transferred to the surface of the agitator A and consumed for the purpose of directly heating the liquid inside the agitation container.

The liquid suctioned in from the suction port 1 immediately changes its direction 90° and moves toward the peripheral rim of the agitator A by means of centrifugal forces. These interconnecting channels can be formed with a drill, for example, which can be used to drill holes to easily form the suction port 1, discharge ports 2 and interconnecting channels 3.

FIG. 2 (b) is a view from the bottom of the agitator A described in FIG. 1, where one suction port 1, four discharge ports 2 and four interconnecting channels 3 are provided in this example.

FIG. 2 (c) is a side view of the agitator A described in FIG. 1, where discharge ports 2 are noted on the side face of the agitator A.

FIG. 2 (d) shows an agitator A with larger heaters 4. By using these larger heaters 4, the interior of the interconnecting channels 3 can be heated in a more reliable manner.

While the suction port 1 has a circular cross-section and the discharge port 2 has a rectangular cross-section in FIG. 2, the cross-section shape of the suction port 1 or discharge port 2 is not limited in any way under the present invention, where a circle, oval, triangle, diamond or other desired shape may be used. Similarly, the cross-section shape of the interconnecting channel 3 is not limited in any way. Also, the suction port 1, interconnecting channel 3 and discharge port 2 may each have a different cross-section area.

FIG. 3 (a) is a section view of an agitator A that, unlike the agitator shown in FIG.

1 above, has four suction ports 1 on the side of the agitator not connected to the rotating shaft S, and four discharge ports 2 on the side face of the agitator A, all of which are provided at equal intervals, with one suction port 1 connecting to one discharge port 2 via an interconnecting channel 3, as shown in FIG. 3 (b).

Also, heaters 4 are provided above and below each interconnecting channel 3, and these individual heaters 4 heat the liquid inside the interconnecting channel 3.

With the agitator A shown in FIGS. 4 (a) and 4 (b), the suction ports 1, discharge ports 2, and interconnecting channels 3 are placed in the same manner as described in FIG. 3 above, except that the heaters 4 are not positioned above and below the interconnecting channels 3; instead, they are positioned on the sides of the interconnecting channels 3.

Such placement allows the thickness of the agitator A to be reduced, which in turn reduces the resistance due to the rotation of the agitator A, especially when a liquid of high viscosity is agitated, and eventually reduces the required energy, as well.

FIG. 5 is a variation example of the agitator A shown in FIG. 2. In this example, two levels of interconnecting channels 3 and discharge ports 2 are provided in the axial direction of the agitator A, while there is only one suction port 1, and the liquid suctioned in from this suction port 1 is distributed to the two levels of interconnecting channels 3.

In this example, three levels of heaters 4 may be provided in a manner sandwiching the two levels of interconnecting channels 3.

According to this structure, the amount of liquid that can be discharged from the discharge ports 2 of the agitator can be increased, and this in turn allows for quicker agitation.

FIG. 6 illustrates an example based on the agitator A shown in FIG. 1, where the suction port 1 is positioned away from the interconnecting channels and the suction port 1 and interconnecting channels 3 are connected by a long vertical interconnecting channel 5 provided on the rotating shaft.

According to the agitator A of this type, liquid near the bottom face of the agitation container can be suctioned in from the suction port 1 and then supplied to the interconnecting channels 3 through the vertical interconnecting channel 5, and finally discharged from the discharge ports 2, for example. Positioning the suction port 1 near the bottom face of the agitation container, as is the case here, is effective on, for example, a liquid containing particles and block objects that have precipitated, because these precipitates can be suctioned in from the suction port 1 and discharged from the discharge ports 2 together with the liquid, thus causing the precipitates to be agitated actively.

Here, the positions of the discharge ports 2 may be adjusted to near the liquid surface inside the agitation container or in the liquid near the center of the height of liquid, to plan from which position the liquid should be suctioned in and to which position it should be discharged by considering the depth of liquid in the agitation container, so that an agitator A whose vertical interconnecting channel 5 has been adjusted in length according to the plan can be adopted.

FIG. 7 (a) is a variation example of the agitator A shown in FIG. 6. The length of the vertical interconnecting channel 5 of the agitator A shown in FIG. 6 has been shortened, and heaters 4 have also been installed around the vertical interconnecting channel 5, so that the liquid that has been suctioned in can be heated as it passes through this longer interconnecting channel 5. This allows for the liquid to be heated to a higher temperature, or to a specified temperature at a slower rate of rise in temperature, while passing through the vertical interconnecting channel 5.

Additionally, because the vertical interconnecting channel 5, interconnecting channels 3 and heaters 4 around them are covered with a cover 6 in such a way that a conical surface is formed from the discharge ports 2 to the suction port 1, the resistance that generates when the agitator is pushed in to a liquid, especially a liquid of high viscosity, can be reduced. Furthermore, when the agitator A rotates, some liquid near the suction port 1 turns together with the agitator A according to the rotation of the agitator A, and the resulting centrifugal forces cause the liquid to rise along the surface of the agitator A, and this action also helps agitate the liquid.

As a result of the above, flows of liquid around the agitator A become smoother, which reduces the possibility of the liquid stagnating and preventing uniform heating of the entire liquid.

The surface of the cover 6 in FIG. 7 (a) is formed in a manner forming a concave shape toward the vertical interconnecting channel 5 and interconnecting channels 3 of the agitator A; on the other hand, this surface has a roughly hemispherical shape in FIG. 7 (b), which is a variation example of FIG. 7 (a), as the areas between the discharge ports 2 and suction port 1 are covered with the cover 6 in a manner forming a convex shape.

According to this shape, effects similar to those achieved by the agitator A shown in FIG. 7 (a) above can be demonstrated.

These covers 6 of the agitators A shown in FIGS. 7 (a) and (b) may be hollow or solid. The interior structure and material of the cover may be determined by considering the torque needed to rotate the agitator A, its buoyancy in the liquid, and the like. For the material, any desired material such as metal, resin, wood, ceramics, etc., may be adopted; however, the material must not change the properties of the liquid to be agitated or particles and block objects contained in the liquid, and any material that changes the properties by the liquid to be agitated or particles and block objects contained in the liquid cannot be used. Also, particularly when resin is used, molten resin may be poured into the forming dies in which heaters and necessary wires are already placed, to integrally combine the cover and heaters.

FIG. 7 (c) shows an agitator A with larger heaters 4, and by using these heaters 4, the interior of the interconnecting channels 3 can be heated in a more reliable manner.

It should be noted that, while the figures in FIG. 7 show agitators A whose shape is changed only at the bottom side, the top side may also be formed in a semispherical shape, etc., to further enhance the agitation capability as a result.

FIG. 8 provides an example based on the agitator A shown in FIG. 2, for example, where the interconnecting channels 3 have a different shape, and is a view from the bottom of the agitator A. Liquid suctioned in from a suction port 1 provided on the rotating shaft S is distributed into four interconnecting channels 3 and moves toward discharge ports 2 while being heated by heaters 4 positioned above and/or below the interconnecting channels 3, for example, and discharged into the surrounding liquid from the discharge ports 2.

Here, the interconnecting channels 3 are gradually curving toward the backward direction of rotation (arrow shown at the suction port 1) of the agitator A. Because the interconnecting channels 3 are curved, the interconnecting channels 3 are heated by the heaters 4 (not illustrated) over a longer length, which allows for greater heating. Additionally, liquid is moving toward the backward direction of rotation of the agitator A at positions inside the interconnecting channels immediately before being discharged from the discharge ports 2. Because this minimizes the resistance that acts upon the surrounding liquid outside the discharge ports 2 when liquid is discharged by means of centrifugal forces, and also because the viscosity of this surrounding liquid causes forces to generate that pull the liquid discharged from the discharge ports 2 toward the surrounding liquid, this allows for smoother agitation.

FIG. 9 is a variation example of FIG. 8, showing an agitator A having longer interconnecting channels 3.

Because the interconnecting channels 3 are longer, they are heated by the heaters 4 over longer lengths, which is useful when heating the liquid suctioned in from the suction port 1 to a higher temperature, or when heating the liquid to a specified temperature by allowing it to be heated slowly inside the interconnecting channels 3.

In addition, because the liquid discharged from the discharge ports 2 is positioned closer to the tangential direction of the agitator A and also closer to the backward direction of rotation of the agitator A, the smoothly heated liquid can be discharged by a larger amount.

FIG. 10 shows a variation example of FIG. 2. The agitator A shown in FIG. 10 is structured in such a way that liquid suctioned in from a suction port 1 provided on the rotating shaft passes through the interconnecting channels 3, during which it is heated by heaters 4, and gets discharged from discharge ports 2. Since the interconnecting channels 3 are made wider, meaning that the liquid contacts the interior face of the interconnecting channels over a larger area, the amount of liquid heated by the heaters increases accordingly. As a result, this structure can be used when heating a liquid to a higher temperature, or to a specified temperature at a slower rate of rise in temperature inside the interconnecting channels.

FIG. 11 shows a variation example of the agitator A shown in FIG. 3. In the example of FIG. 11, suction ports 1 are provided above the agitator A, next to the rotating shaft S of the agitator A. By using the agitator A shown in this FIG. 11, liquid positioned above the agitator A can be suctioned in, heated by heaters 4 inside interconnecting channels 3, and discharged from discharge ports 2, inside an agitation container.

When such agitator A is used, the agitator A may be positioned near the bottom face of the agitation container, for example, so that the liquid near the rotating shaft S above the agitator A is suctioned in, while the heated liquid discharged from the discharge ports 2 is made to flow convectively to near the liquid surface by also utilizing the drop in specific gravity as a result of heating, and as this is repeated, the entire liquid can be heated.

FIGS. 12 (a) and (b) show variation examples of FIG. 2. In FIG. 12 (a), the discharge ports 2 are oriented diagonally upward. As a result, in addition to the innate nature of heated liquid to form upward flows when discharged, the liquid is discharged diagonally upward in advance, which strengthens the formation of upward flows and promotes the achievement of total liquid agitation and uniform temperature.

Particularly when such agitator A is positioned near the bottom face of the agitation bath, the entire liquid can be agitated more efficiently.

In FIG. 12 (b), the agitator A is formed with its discharge ports 2 facing diagonally downward, which means that, when the bottom face has a large area and the agitator is relatively small, for example, the agitator A can be positioned near the bottom face of the agitation container to perform agitation. In this case, the heated liquid that naturally flows upward when discharged, does not immediately move upward in the liquid; instead, it diffuses downward by means of centrifugal forces and then moves upward in the liquid. As a result, the entire liquid can be agitated uniformly, even when a particularly small agitator relative to the bottom face of the agitation container is adopted.

FIG. 13 shows a variation example of FIG. 2. In FIG. 13, the interconnecting channels 3 are curved in a direction parallel to the rotating shaft. With the agitator adopting the interconnecting channels 3 of such structure, liquid in the interconnecting channels 3 can be heated uniformly. As a result, flows of liquid in the interconnecting channels 3 become smoother and agitation efficiency can be improved.

The foregoing described the shapes and structures of agitators according to the present invention; however, agitator shapes and structures are not limited to those shown in these drawings, and the numbers of suction ports, discharge ports and interconnecting channels, discharge port orientation, interconnecting channel shape, etc., may be changed as desired based on the above drawings.

1. An agitator supported on a rotating shaft, which has:
a liquid suction port provided on the rotating shaft and/or near the rotating shaft;
a liquid discharge port provided farther away than the liquid suction port from the rotating shaft, which liquid discharge port is interconnected to the liquid suction port through an interconnecting channel; and
a heater provided for heating an interior of the interconnecting channel and/or liquid discharge port.

2. An agitator according to claim 1, wherein the heater is provided adjacent to the interconnecting channel and/or near the liquid discharge port.

3. An agitator according to claim 1, wherein the heater is provided inside the agitator.

4. An agitator according to claim 1, wherein it has one or more liquid suction ports and one or more liquid discharge ports that are independent of each other, and the interconnecting channel is provided in a manner allowing for flows of liquid to be branched.

5. An agitation device comprised by placing one or more agitators according to claim 1 in a direction of the rotating shaft.
